(19) United States
(12) Patent Application Publication
(10) Pub. No.: US 2017/0318781 A1
(43) Pub. Date: Nov. 9, 2017

(54) COMBINED VISUAL AND RF IDENTIFICATION (RFID) TAG

(71) Applicant: Cattle Time, LLC, Atlanta, GA (US)

(72) Inventors: R. Randall Rollins, Atlanta, GA (US); Alan W. Butler, Atlanta, GA (US)

(21) Appl. No.: 15/585,696

(22) Filed: May 3, 2017

Related U.S. Application Data
(60) Provisional application No. 62/331,105, filed on May 3, 2016.

(51) Int. Cl. A01K 11/00; G06K 7/10; G06K 7/00

(52) U.S. Cl. CPC A01K 11/004; G06K 7/10316; A01K 11/006; G06K 7/0008; G06K 7/10198

(57) ABSTRACT

An identification tag is described in which a first tag member is formed of a polymer and includes a front surface. A second tag member, also formed of a polymer but that visually contrasts with the first tag member, includes slots formed as visual indicia that extend through the second tag member. The second tag member is welded to a front surface of the first tag member to expose the front surface of the first tag member through the slots. An RFID inlay, providing a radio frequency identification function, is affixed to the first tag member on a rear surface thereof. A third tag member, also formed of a polymer, is welded to the rear surface of the first tag member to cover and protect the RFID inlay.

### TECHNICAL FIELD

The present invention relates generally to identification tags, and more particularly to animal identification apparatus with visual indicia used to identify specific animals combined with long range radio frequency identification (RFID).

### BACKGROUND

Cattle and other livestock are valuable commodities and must be managed for health and wellbeing. Part of the management task is to track the location of individual animals in a pasture or range. The information as to movement and location can provide valuable insight as to which animals are thriving and which may be distressed.

When livestock are in the field, they are difficult to distinguish from a distance. Terrain and fencing often interferes with observations. Many livestock managers primarily use visual identification tags to assist with identifying specific animals from a distance. For example, U.S. Pat. No. 6,497,062 describes an identification tag for livestock that is formed of layers, where the outer layers of a multi-layer tag include carved-out visual indicia that allow a high contrast background in an inner layer to show through. The tag layers are bonded (welded) together to form an integrated tag. This approach is preferable to a more conventional livestock identification tag where the visual indicia are simply embossed or printed on a surface, which is more subject to wear and tear.

Electronic identification (EID) button tags are also in common use for livestock management. Viable current forms of EID use a passive radio-frequency identification (RFID) technology, since active RFID would require a power source (e.g. a battery), which is difficult to maintain in a cattle herd. One example of a passive RFID tag shown in U.S. Pat. No. 7,726,055, “Electronic Button Tag for Tagging and Identifying Cattle”. Button tags of this sort typically use a passive RFID methodology such as described in U.S. Pat. No. 7,936,272, “Dynamic Antenna Tuning Circuit for a Radio Frequency Identification Reader”. This passive methodology is considered half-duplex (HDX), wherein an RFID reader generates a radio signal that activates and powers the passive RFID tag, which responds by generating and transmitting a low power coded radio signal that is detected by the reader.

The main problem with such passive RFID button tags is that they only work at relatively small distances, e.g. on the order of a few feet or meters. This is due to the very small transmitting powers that can be achieved with passive RFID, where the power for the transmitter is obtained from an energizing RF signal transmitted from a reader, which must be physically nearby in order to provide sufficient charging power for an internal power storage device for the RFID transmitter.

Some manufacturers, e.g. Allflex USA, Inc., provide matched pair tags as a product, i.e. combined visual/EID tags that join a visual identification tag and a button type RFID tag into a single tag that is affixed to the livestock. See, e.g. Allflex USA, Inc. “Visual Matched Sets” http://www.allflexusa.com/our-products/cattle/category/eid-visual-matched-sets. However, this approach requires attachment of both the visual ID tag and separate attachment of the RFID button tag, which increases the mutilation of the animal because of dual attachment requirements.

Another approach to a combined EID and visual tag is described in U.S. Pat. No. 8,573,502, “Modular Visual and Electronic Identification Tag.” This approach involves combining a separate EID button tag and a visual tag, where the visual and RFID/EID are mated on the tag but can be subsequently separated to facilitate re-use of the EID or the visual tag. This has the same drawback as other RFID button tags, namely, that of limited reading range.

Thus a need has remained for more permanent visual indicia on identification tags with a form of RFID that provides acceptable range of operability at various orientations and distances.

### BRIEF DESCRIPTION OF THE DRAWINGS

Preferred embodiments are described below with reference to the following accompanying drawings.

FIG. 1 is an enlarged frontal elevation of an animal tag embodying features of the present disclosure.

FIG. 2 is a bottom plan view of the tag shown in FIG. 1

FIG. 3 is a perspective view of the present tag.

FIG. 4 is an enlarged partial cross-sectional view of the present tag.

FIG. 5 is a perspective exploded view of the present tag.

FIG. 6 is a diagrammatic view exemplifying the process for producing the present tags.

FIG. 7 is an enlarged back elevation of the tag shown in FIG. 1, showing the position of the RFID element.

### DETAILED DESCRIPTION

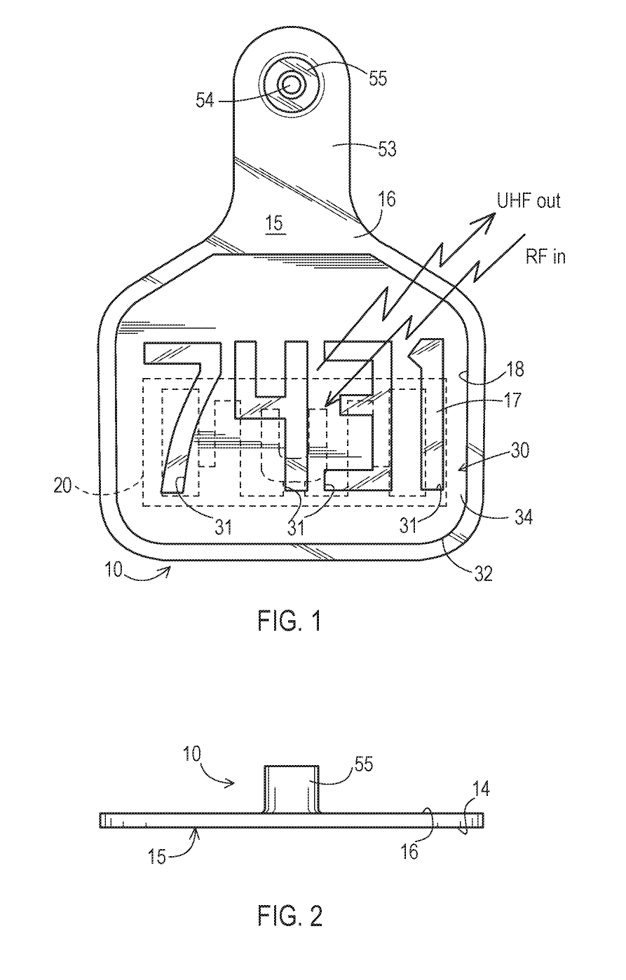

In a first aspect, and referring to FIG. 1, the present tag 10 comprises a first tag member 15 formed of a polymer and including a front surface 16, and a second tag member 30, formed of a polymer that visually contrasts with the first tag member. The second tag member 30 includes slots formed as visual indicia, extending through the second tag member and exposing the front surface 16 of the first tag member 15 through the slots 31. The second tag member 30 is welded to the front surface 16 of the first tag member 15 with the slots 31 opening against the front surface 16.

In another aspect, the tag 10 comprises a planar, flat ultrahigh frequency (UHF) RFID inlay 20 that is positioned on the rear or back surface 14 of the first tag member 15. The RFID inlay 20 provided a remotely readable RF identification function to complement the visual identification function as described herein. As will be described, preferably the RFID inlay 20 is positioned underneath a third tag member 40, which encloses and protects the RFID inlay 20. This is shown more fully in FIG. 4. Preferably, the dimensions of the RFID inlay 20 are such that the metallization of the antenna portion occupies as much surface area on the overall surface area of the tag 10 as possible, while still covered and protected by the third tag member 40. Further, the third tag member 40 is affixed to the back surface 14 of the first tag member 15 with RF welding around a periphery that securely fastens the third tag member over the RFID inlay 20 without operatively damaging the function of the RFID inlay.

Preferably, the RFID inlay 20 is a passive UHF RFID inlay, such as a type AD-383u7, manufactured by Avery Dennison Corp. (Miamisburg, Ohio, USA). Details of the preferred RFID inlay are available from the manufacturer. The preferred RFID inlay is a passive, ISO-18000-6C, EPC Class 1, Gen 2 inlay, operating at between 860 MHz and 960 MHz, using 128 bit EPC memory, with TID memory of 96 bits, pre-encoded for serialization. Preferably, the serialization scheme employed will be consistent with, if not identical to, the serialization of the visual indicia employed. Preferably, inlays having a pressure sensitive adhesive on one side are employed, to allow affixation to a surface of the first tag member 15, as described herein.

While the preferred RFID inlay is readily available from the identified manufacturer, those skilled in the art will understand that the pattern and area of antenna metallization, coupled with circuitry for receiving RF energy from a reading wand for inductive power, energy storage (typically by capacitance), and circuitry for generating the return RF data-bearing signal, have an influence on the range at which a tag can be read from a distance. Therefore, although the preferred tag is disclosed and described with a preferred RFID inlay, it will be understood that other designs of RFID antennas, patterns of metallization, orientation of the antenna metallization relative to symmetry of the tag, circuit powering, energy storage, and coded ID signal protocols, frequencies, etc. for transmission, can have an effect on the reading range. It is specifically contemplated that other RFID circuit and antenna designs, not necessarily limited to preconfigured RFID inlays, may be utilized in embodiments of the tag, so as to provide for other features such as orientation of reading wand to a tag to be read and distance of reading.

In another aspect, the tag 10 comprises a first tag member 15 formed of flexible thermoplastic material including a front surface 16 with a recess surface 17 formed therein and bounded by a marginal peripheral recess edge 18 extending from the recess surface to the front surface 16. A second tag member 30 includes outward edge surfaces 32 and is formed of flexible thermoplastic material but visually contrasting with the first tag member 15. The second tag member 30 is radio frequency welded to the first tag member 15, against the recess surface 17 and with the outward edge surfaces 32 adjacent the marginal peripheral recess edge 18. The second tag member 30 includes laser cut through slots 31 formed as visual indicia, extending through the second tag member 30.

In a further aspect, a process for producing an identification tag 10 comprises a number of steps, including obtaining a first tag member 15 including a front surface 16, followed by the step of laser cutting indicia through a second tag member 30. In another step, the second tag member 30 is radio frequency welded to the first tag member front surface 16.

In exemplary forms, the present tag 10 comprises at least three components: the first tag member 15, a second tag member 30 permanently secured to the first tag member, and an RFID inlay 20, also secured to the first tag member. In a preferred aspect, the present tag 10 further comprises a third tag member 40 permanently fastened to the first tag member, enclosing and protecting the RFID inlay 20. It is preferred that both first, second, and third tag members be formed of similar if not identical material, but with at least the second tag member 30 being visually distinguishable from the first member 15. Optionally, the third tag member 40 is also visually distinguishable from the first member 15.

Most preferably, the visual distinction is made by providing a coloration distinction, and by slots 31 (FIG. 1) that extend through the second tag member 30 to permit visual access to the differently colored first tag below. For example the first tag member 15 may be black (or yellow) in color and the second tag member 30 may be white (or purple). In this way, the distinctive colors will visually emphasize the indicia formed by the laser cut slots 31.

The preferred material for the tags is a flexible polyurethane that may be injection molded to form the first tag member 15, and preferably be provided in sheets or rolls for laser cutting and formation of the second tag member 30 and third tag member 40. It is preferable that the materials comprising the members 15, 30, 40 be of such similar composition to facilitate welding, most preferably by radio frequency, of the two tag members. Flexible polyurethane may be welded by radio frequency and includes properties of resilience, high wear resistance, color fastness, and toughness that lend themselves well to manufacture and use in the present invention.

Radio frequency welding has been found to far surpass the bond produced by mechanical fasteners or by adhesives. This is true also for providing a protective covering by the third tag member 40 for the RFID inlay 20. Mechanically joined or adhesively joined tag members typically will not stay laminated in adverse conditions over long periods of time. Polyurethane tag members that are radio frequency welded, on the other hand, form an integral unit, with the two members 15, 30 (or three members 15, 30, 40) fused together into one. Delamination is therefore not a significant likelihood regardless of wear or weather conditions over time. Further, the different pigmentation of the two members and the laser cut slots assure that the indicia will not easily erode with time and wear, especially as compared with prior tags where indicia was silk screened or otherwise applied as a coating on a substrate. More discussion regarding radio frequency welding of the tag components will be discussed later on in this application.

It is preferred that the first tag member 15 include at least one of the recess surfaces 17 to receive the second tag member 30. In the exemplified forms, it may be preferred to include two of the recess surfaces 17 on opposed sides of the first tag member 15 to receive the second tag member 30 and third tag member 40. In either instance, the recess surfaces 17 and second tag members 30 and third tag member 40 may be the same, and fastening by welding may be carried out in the same manner for both sides.

The recess or recessed surface 17 may be integrally formed in the first tag member 15 by the same injection molding process used to form the tag body. Each recessed surface 17 is defined by the edge 18, which may be of any desired shape. It may be formed to a depth in the first tag member 15 that is preferably at least equal to the thickness of the second tag member 30.

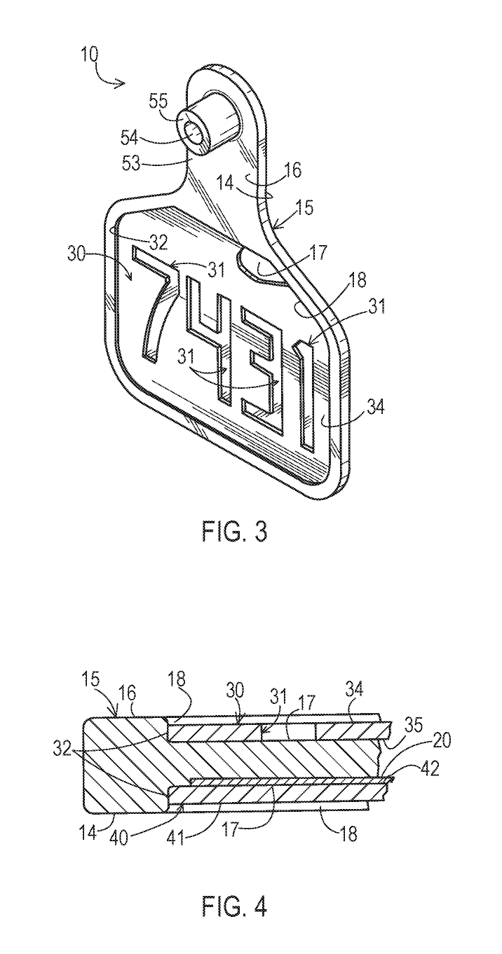

The examples illustrated in FIGS. 3 and 4 include a two sided, two recess first tag member 15 with recess surfaces 17 formed on opposite sides to depths that are greater than the thickness dimensions of the second tag members welded thereto. Most preferably each of the recessed surfaces 17 will occupy a significant part of the adjacent surface of the first tag member 15, and the associated second tag member 30 and third tag member 40 will be of a complementary shape so as to fit within the recessed surface 17. Outer edges 32 of the second tag member 30 and third tag member 40 will thus be adjacent to and be protected by the recess edges 18 of the first tag member 15.

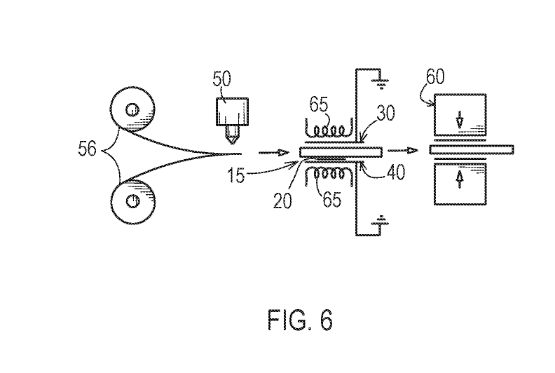

The slots 31 formed in second tag member 30 are most preferably laser cut through the thickness dimension thereof. A commercially available laser cutting machine 50 (FIG. 6) may be used to cut the indicia 31 and to cut the outline of successive second tag members 30 from a sheet or a roll. Two such rolls 55 are diagrammatically shown in FIG. 6, aligned so as to allow the laser 50 to cut two tag members simultaneously. Other arrangements including cutting single tags from a single roll or sheet could be used as well.

It is preferable that the indicia be laser cut, since the edges of the cuts will typically be sharp and crisp without a noticeable distracting raised edge, burr, or selvage formed above or to one side of the second tag member face. Such imperfections are typically found in instances where a die stamp, high speed etching tool, or a heated stylus is used to create indicia in polymer materials. Such raised edges are typically not consistent around the cut area, therefore creating unreliable visual access to the slot when viewed at an angle. Further, a raised burr or selvage can snag and cause obstruction of the adjacent indicia by accumulating snagged debris that can cover or partially obstruct visual access to the adjacent indicia.

It is also preferable to use laser cut indicia since commercially available laser cutters 50 can be operated to quickly cut successive indicia that may vary from one tag to another. For example, in many instances it may be desirable to provide a series of tags with a serial progression of indicia such as consecutive numbers, letters or combinations thereof. Commercially available laser cutters 50 may be programmed to cut such successive distinguishing indicia in the second tag members 30.

Further, the laser cutting operation may be performed in a substantially automated process in which the second tag members 30 are progressively cut from a sheet or roll of material prior to being affixed to successive first tag members 15. Still further, if two sides of a finished tag are to include the second tag members, with identical indicia on both sides, an indicia forming laser cut may be made simultaneously through two thicknesses of the preferred polymer material to form two substantially identical second tag members, one of which serves as the third tag member 40. This would be for an embodiment where two second tag members 30, each bearing cut indicia, are provided on opposite sides of a first tag member. In such an embodiment, the openings forming the indicia may expose portions of the RFID inlay 20, which may be acceptable in some applications where it is desired that the rear surface of the tag 10 has the same indicia as the front surface, and it is deemed sufficient to provide partial coverage of the RFID inlay 20 by a third tag member 40 having indicia.

The first tag member 15 includes a front surface 16 and a back surface 14. The surfaces are preferably planar and spaced apart by the thickness of the member 15. The thickness dimension in a preferred form is between about 0.060 inches and 0.12 inches and most preferably approximately 0.090 inches. This dimension is preferably greater than that of the second tag member 30 to allow some reduction in thickness (about 0.03 inches) through the first tag member for formation of the recessed surface 17 and peripheral edge 18 to receive the second tag member 30.

The second tag member 30 also includes a front surface 34 and a back surface 35. The thickness dimension of the second tag member 30 is preferably constant and less than the thickness dimension of the first tag member 15. Most preferably, the thickness dimension of the second tag member 30 is slightly less than or not substantially greater than the depth of the recessed surfaces 17 (about 0.03 inches). In a preferred example the second tag member 30 includes a thickness dimension of approximately 0.02 inches. Such relatively thin material may be easily laser cut and can be easily welded by radio frequency welding to the first tag member 15.

The first and second tag members 15, 30 are affixed, with the front surface 16 of the first tag member 15 in flush abutment with the back surface 35 of the second tag member. This is preferably accomplished as indicated above, by radio frequency welding. With the preferred polyurethane materials and the preferred thickness dimensions related above, radio frequency welding of the components may be accomplished with a conventional radio frequency welding machine 60 at a frequency preferably of less than approximately 50 megahertz at a power intensity of between approximately 10 and 20 kilowatts. In a preferred example, tags of the above nature may be welded using a frequency of approximately 27 megahertz at a power intensity of between approximately 10 and 20 kilowatts.

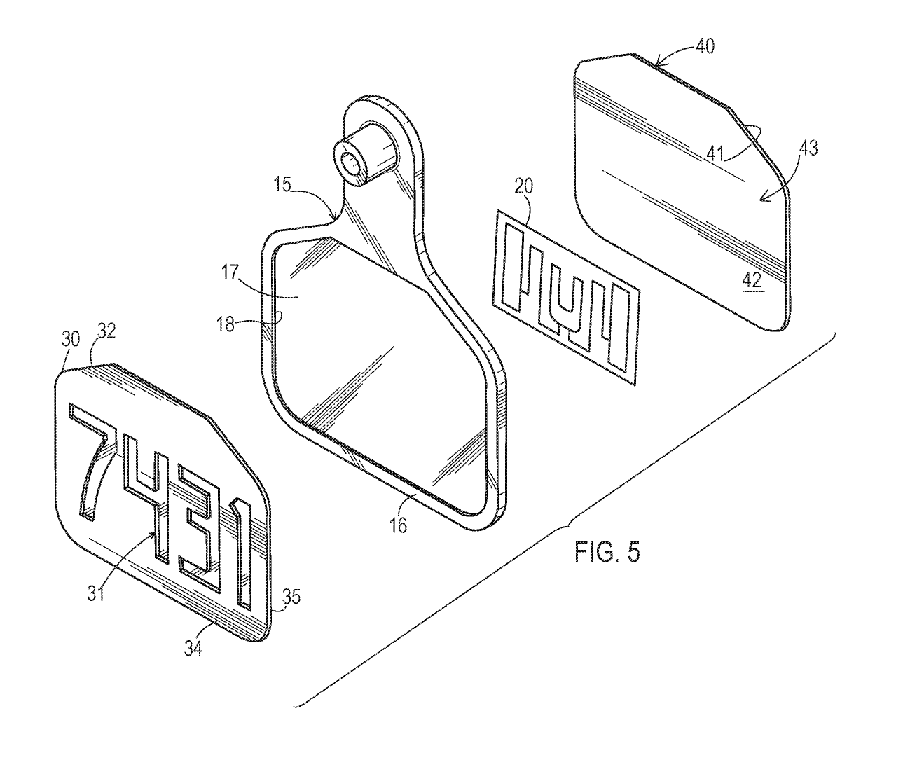

In order to allow visual identification from a broad range of angles (front, back, sides) it may be desirable, as briefly indicated above, to provide indicia on both sides of the tag 10. In a preferred form (FIGS. 4, 5) a third tag member 40 is provided, affixed to the back surface 14 of the first tag member 15. As mentioned above, such an embodiment utilizing a third tag member 40 having indicia may expose portions of the RFID inlay 20, which may be acceptable in some applications. Alternatively, the third tag member 40 may be solid and continuous (i.e. without laser cut indicia), which would provide complete coverage and protection of the RFID inlay 20.

The third tag member 40 may be substantially identical to the second tag member 30, and include the same (but not necessarily) indicia. As such, the third tag member may include a front surface 41 and a back surface 42 that may be substantially identical to those of the second tag member 30. The third tag member may also include through slots (not shown) that may be identical to the second member slots 31. Like slots 31, the through slots (if any) in the third tag member 40 are preferably formed as visual indicia, extending through the third tag member from the front surface 41 to the back surface 42.

The thickness dimension of the third tag member 40 is preferably the same as that of the second tag member 30. Thus, as shown in FIG. 4, the overall thickness dimension of the tag 10, at least in the area of the slots 31, 43 is the sum of the thickness dimensions of the first tag member 15 (between the recess surfaces 17), the RFID inlay 20, the second tag member 30, and the third tag member 40. This total thickness may be approximately equal to the maximum thickness dimension of the first tag member.

The third tag member 40 may be permanently attached to the first tag member 15 in the manner described above, using radio frequency welding. It is preferred, however that the three members be preheated before application of radio frequency to minimize the power requirements for the weld. Preheating to a temperature of between approximately 120° F. and 180° F. is generally desirable, and more specifically, preheating to approximately 150° F. is preferred.

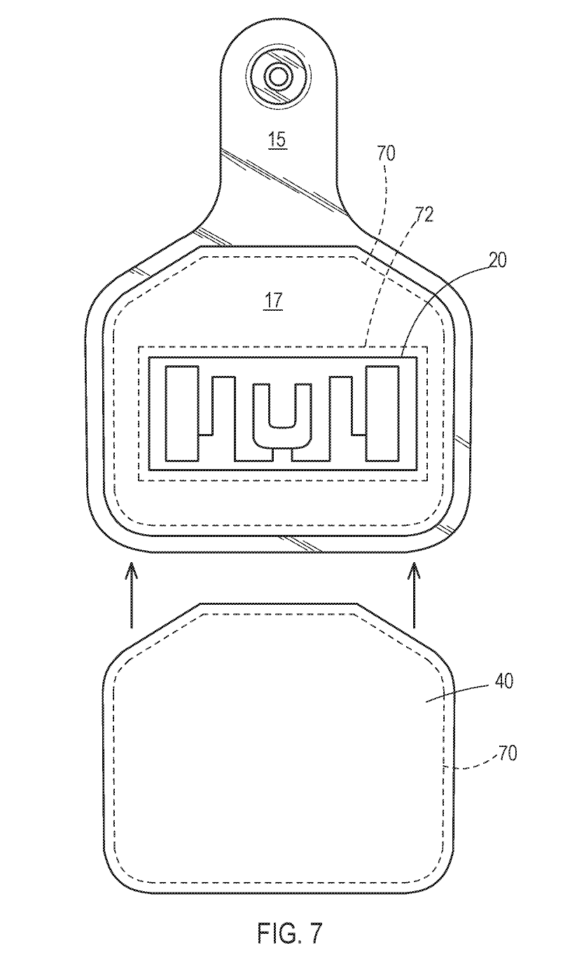

Referring now to FIG. 7, preferably, the radio frequency welding of the third tag member 40 to the first tag member 15 is made so that the third tag member completely covers the RFID inlay 20, with welding energy applied to the peripheral edges 70 of the third tag member 40, avoiding the area outlined and occupied by the RFID inlay 20, so as to avoid damaging the circuit components, memory, and antenna metallization of the RFID inlay 20. If further weld bonding is desired, RF welding energy may be selectively applied to a larger region of the third tag member up to a point or boundary such as that shown at 72, provided that the RF energy is sufficiently focused to avoid significantly impinging upon the RFID inlay 20 or at levels that may damage the RFID inlay circuity and antenna metallization.

Referring again to FIG. 1, in instances where the present tags are to be used for identification of animals, at least one tag member (preferably the first tag member 15) may be provided with an upstanding tab 53. An aperture 54 may be formed through the tab. The aperture 54 may be provided to receive a spike (not shown) or other tag securing device. A boss 55 may be provided about the aperture 54 to strengthen the tab against the spike or other fastener.

In the examples shown, only the first tag member 15 is provided with tabs and apertures. However, other variations where the two or three tag members are identical, all members may be provided with tabs and apertures.

Referring to FIG. 6, in preferred forms of the present process, the first step is obtaining a first tag member 15 including a front surface 16. This may be done using injection molding processes by which the described first tag member 15 may be produced from a polymer, preferably a flexible injectable polyurethane material. Next, a laser cutting machine 50 may be used for the step of laser cutting indicia through a second tag member. During this step, the outline or marginal edges of the successive second tag members may also be cut. Further, as shown in the schematic in FIG. 6, second and third tag members 30 and 40 may be laser cut simultaneously from rolls 56 of the preferred material (which is most preferably the same material used for the first tag members 15).

Next, a preconfigured, initialized RFID inlay 20 is affixed to the appropriate rear surface of the first tag member 15. Typically, this step involves affixing the RFID inlay with the adhesive that is provided with the stock RFID inlays, as provided by the manufacturer

Finally, the step of radio frequency welding the second tag member to the first tag member front surface 16 is performed. Most preferably, at least the first tag member 15 and preferably all tag members are pre-heated prior to the welding step, as graphically shown in FIG. 6 by heaters 65, to a pre-heated temperature between approximately 120° F. and 180° F., and most preferably approximately 150° F.

The pre-heated tag members 30, 40 are then aligned and fitted into the recess surfaces 17, with the third tag member 40 covering the RFID inlay 20. It may be desirable at this point, that the third tag member be reversed prior or during this step in order to correctly orient the indicia thereon, otherwise letters or numbers could appear as an illegible mirror image. If indicia is used that is visually symmetrical, or that is not directionally sensitive, there is no need to include a reversal step.

It is preferred that the second tag members 30 (and third tag members 40 if used) be pressed into the recessed surfaces 17 following the laser cutting step, after applying the RFID inlay 20, and preferably during the welding step. This can be accomplished by the welder 60. The radio frequency welder 60 may thus be operated to press and weld the tag members together preferably using radio frequency of less than approximately 50 megahertz (preferably about 27 megahertz) at a power intensity of between approximately 10 and 20 kilowatts. This effectively welds the tag members together, completing the formation of the finished tag.

It is also preferred and desirable that all portions of the process of applying the second and third tag members to the first tag member, during heating and welding, include applying a suitable anti-static electrical discharge grounding, as shown in FIG. 6, so as to prevent undesirable electrostatic discharge (ESD) that might damage or destroy the circuit on the RFID inlay, as RFID inlays are known to be susceptible to damage by ESD.

When manufactured as described above and attached to an animal, the present tag 10 is nearly indestructible and will clearly show the identification indicia for the life of the animal, and provides a good, long range RFID function, at a variety of angles of orientation of an RFID reader and its antenna, relative to the antenna orientation of the RFID inlay 20. As to visual identification, this is due to the contrasting materials of the first, second, and third (if used) tag members, superimposed on one another and with the slots clearly outlining the selected indicia. As there is no “painted” on indicia, there is nothing exposed to wear other than the tag materials themselves. Since the tag materials are selected from materials known for long life and excellent wear properties, the indicia will inherently last as long as the materials forming them.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. An identification tag, comprising:
a first tag member formed of a polymer and including a front surface;
a second tag member formed of a polymer that visually contrasts with the first tag member;
an RFID inlay positioned on the first tag member on a surface thereof; and
a third tag member formed of a polymer that substantially covers and protects the RFID inlay;
wherein at least the second tag member includes slots formed as visual indicia, extending through the second tag member and exposing the front surface of the first tag member through the slots;
wherein the second tag member is welded to the front surface of the first tag member with the slots opening against the front surface of the first tag member; and
wherein the third tag member is welded to the rear surface of the first tag member and protectively covering the RFID inlay.

2. An identification tag as claimed by claim 1, wherein the first and second tag members are secured together by radio frequency welding.

3. An identification tag as claimed by claim 2, wherein the first tag member and the second tag member are welded in a linear, generally rectangular outline that is spaced apart from the outer peripheral edge of the RFID inlay so as to avoid RF energy from the welding to impinge upon the RFID inlay.

4. An identification tag as claimed by claim 1, wherein the RFID inlay is grounded during the welding operation to minimize risk of damage from stray currents.

5. An identification tag, comprising:
a first-tag member formed of a polymer and including a front surface;
a second tag member formed of a polymer that visually contrasts with the first tag member; and
an RFID inlay positioned on the first tag member on a surface thereof;
wherein the second tag member includes slots formed as visual indicia, extending through the second tag member and exposing the front surface of the first tag member through the slots;
wherein the second tag member is welded to the front surface of the first tag member with the slots opening against the front surface of the first tag member; and
wherein the first and second tag members are formed of thermoplastic elastomeric material and are secured together by radio frequency welding.

6. An identification tag, as claimed by claim 5, wherein the slots are laser cut through the second tag member.

7. An identification tag, as claimed by claim 5, wherein the first and second tag members are formed of at least substantially similar thermoplastic materials.

8. (canceled)

9. (canceled)

10. An identification tag, comprising:
a first tag member formed of flexible thermoplastic material including a front surface with a recess surface formed therein and bounded by a marginal peripheral recess edge extending from the recess surface to the front surface;
a second tag member having outward edge surfaces and formed of flexible thermoplastic material but visually contrasting with the first tag member; and
an RFID inlay positioned on the first tag member on a surface thereof;
wherein the second tag member is radio frequency welded to the first tag member against the recess surface and with the outward edge surfaces adjacent the marginal peripheral recess edge; and
wherein the second tag member includes laser cut through slots formed as visual indicia, extending through the second tag member.

11. An identification tag, as claimed by claim 10, wherein the second tag member includes a thickness dimension that is less than a distance dimension from the recess surface to the front surface of the first tag member.

12. An identification tag, as claimed by claim 10, wherein the first and second tag members are formed of polyurethane.
